(19) United States
(12) Patent Application Publication
(10) Pub. No.: US 2011/0104927 A1
(43) Pub. Date: May 5, 2011

(54) BURN-IN SOCKET

(75) Inventors: QUAN WANG, Shenzhen (CN); ZHEN-QI YANG, Shenzhen (CN); MING-YUE CHEN, Tu-Cheng (TW)

(73) Assignee: HON HAI PRECISION INDUSTRY CO., LTD., Tu-Cheng (TW)

(21) Appl. No.: 12/917,511

(22) Filed: Nov. 2, 2010

(30) Foreign Application Priority Data
Nov. 2, 2009 (CN) 200920313854.X

(51) Int. Cl. H01R 13/62

(52) U.S. Cl. 439/330

(57) ABSTRACT

A burn-in socket (100) includes an insulative main body (1) defines a plurality of passageways; a slider (2) and a bottom plate (3) fits to the insulative main body; a plurality of contacts (16) receives in the insulative main body and the slider. The actuator frame (4) attached to the insulative main body forms a plurality of posts (44) positioning in the slots of the insulative body, the actuator frame includes a pair of opposing walls, each opposing wall has an upper guiding surface (45) protruding into the receiving room and a lower guiding surface (46) returns back towards the opposite wall both along the mating direction.

### BACKGROUND OF THE INVENTION

1. Field of the Invention

The present invention relates to a burn-in socket, and more particularly to a burn-in socket having an actuator frame for aligning a central processing unit (CPU).

2. Description of Related Patent

In a test socket, a CPU is installed in a printed circuit board to construct a complete circuit with continuous functions. To ensure the functionality and reliability of the CPU during service life, the CPU must be tested before actual field application. The CPU in the test usually undergoes an extended period of time at a high temperature, so that any earlier failure of a package can be detected accordingly. A so-called testing socket is provided, in which the CPU are under a voltage source that is greater than the rated value; those CPU that continue to perform satisfactorily are then approved for shipment.

The burn-in socket includes an insulative main body, an actuator frame moveably coupled to the insulative main body, and a slider disposed therebetween with a plurality of contacts disposed therein. The slider and the actuator frame define a receiving space for receiving a CPU. The actuator frame has a leading surface to guide the CPU to a preset position and rectangular bottom edges interacting with sides of the CPU. In this situation, the sharp bottom edges might scratch the sides of the CPU or its contacts and even damage the CPU or the contacts. The rectangular bottom edges are designed to define a space to fit the CPU precisely so that essentially they do not tolerate any variation or misalignment in connection with the CPU.

Therefore, a new burn-in socket with an actuator frame which overcomes the above-mentioned disadvantages is desired.

### BRIEF SUMMARY OF THE INVENTION

Accordingly, an object of the present invention is to provide a burn-in socket with actuator frame in which a CPU can be precisely disposed in a center thereof.

In order to achieve afore-mentioned object, a burn-in socket comprises an insulative main body defines a plurality of passageways; a slider and a bottom plate fits to the insulative main body; a plurality of contacts receives in the insulative main body and the slider, an actuator frame above the insulative main body and the slider, comprises parallel side walls and a pair of upper guiding surfaces for guide the CPU thereof, and a pair of lower guiding surfaces on the low edge of the actuator frame, the distance between the lower guiding surfaces is diminishingly from lower to upper to supply more spaces to adjust the CPU.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective, assembled view of a burn-in socket in accordance to the present invention;

FIG. 2 is a perspective, exploded view of the burn-in socket;

FIG. 3 is another perspective, exploded view of the burn-in socket; and

FIG. 4 is a cross-sectional view of the burn-in socket taken along line 4-4 of the FIG. 1.

### DETAILED DESCRIPTION OF THE INVENTION

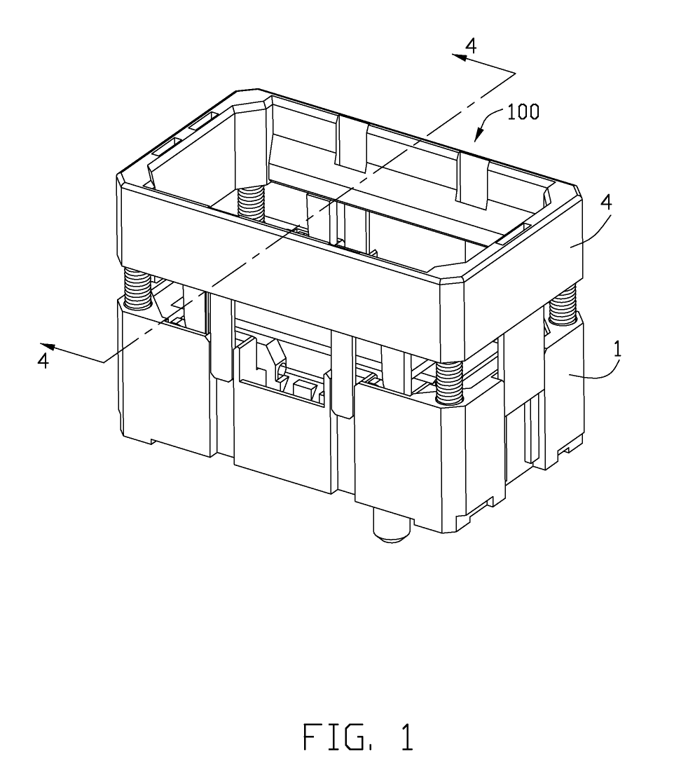

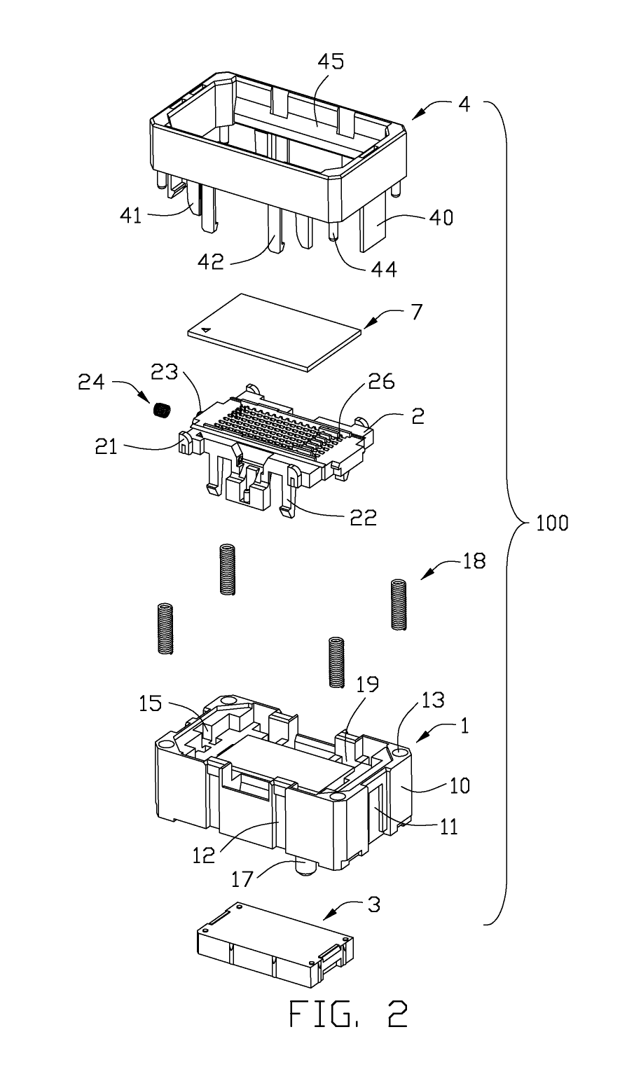

Referring to FIGS. 1-4, a burn-in socket or connector of the present invention is used for connecting a central processing unit (CPU) 7 and a printed circuit board (PCB) (not shown). The burn-in socket comprises an insulative main body 1, an actuator frame 4 mounted on the insulative main body 1 in a floating manner along a vertical direction, a slider 2 carrying a plurality of contacts 16, the slider being set between the insulative main body 1 and the actuator frame 4 in a floating manner along a lengthwise direction, and a bottom plate 3 mounted under the insulative main body 1. The slider 2, the insulative main body 1, and the bottom plate 3 have a plurality of passageways (not shown) to receive the contacts 16 and they are all structured and arranged in a way known in this art.

The insulative main body 1 is configured to a rectangular shape, and comprises four side walls 10 and a bottom (not labeled) and a plurality of middle passageways therein, the bottom separates the insulative main body 1 and forms an upper room (not labeled) and a lower room (not labeled) with the side walls 10. The slider 2 and the bottom plate 3 receive in the upper room and lower room separately. There are a number of first out grooves 11 on the outside of the short side walls (not labeled) and a hollow 15 on inner side of one short side wall, and a number of second out grooves 12 on the outside of the long side walls (not labeled) and a number of first inner grooves 19 on the inner side of the long side walls, and there are slots 13 on four upper side corners of the insulative main body 1 and four vertical springs 18 disposed therein, at least two first post 17 set on the down side of the insulative main body 1 to position the insulative main body 1 on the PCB.

The bottom plate 3 has a plurality of lower passageways correspond to the upper passageways 26 and the middle passageways, the contacts 16 exposed from the top surface of the slider 2 to hold the solder ball (not shown) of the CPU 7, and part of the contact 16 received in the passageways of the slider, bottom of the insulative main body and the bottom plate, and the lower end of the contact 16 extrude from the bottom of the bottom plate 3 to contact the PCB electrically.

The side walls 10 and the bottom of the insulative main body 1 defines a upper room to receive the slider 2, and a number of hooks 22 hang from sides of the slider 2 corresponding to the first inner grooves 19, and the first inner grooves 19 are wider than the hooks 22 makes the slider 2 movable relative to the insulative main body 1 in the lengthwise direction. And a third post 23 defined on one end of the slider 2 in the lengthwise direction corresponding to the hollow 15, and a spring 24 between the slider 2 and the hollow 15 makes the slider 2 reposition.

A number of first latches 40, 42 hang from the actuator frame 4 and mate with the first and second out grooves 11, 12 on the outside of the side walls 10 to restrict the displacement of the actuator frame 4 relative to the insulative main body 1. The actuator frame 4 defines four second posts 44 on the four corners relative to the slots 13, and said springs 18 between the actuator frame 4 and the insulative main body 1 makes the actuator frame 4 reposition. Several first guide portions 41 hang from the actuator frame 4 and mate with corresponding second guide portion 21 defined by the slider 2 to drive the slider 2 slide along a longitudinal direction.

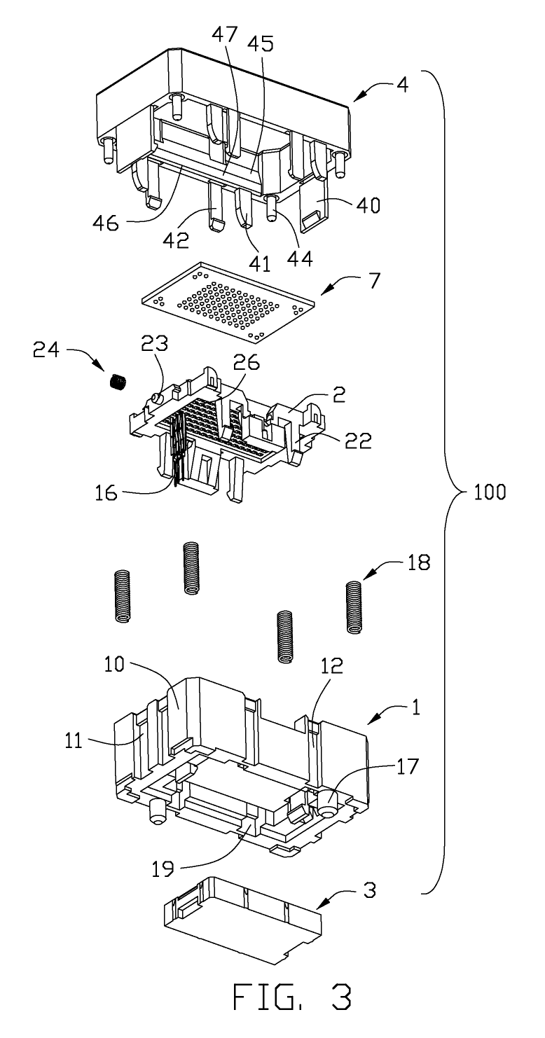

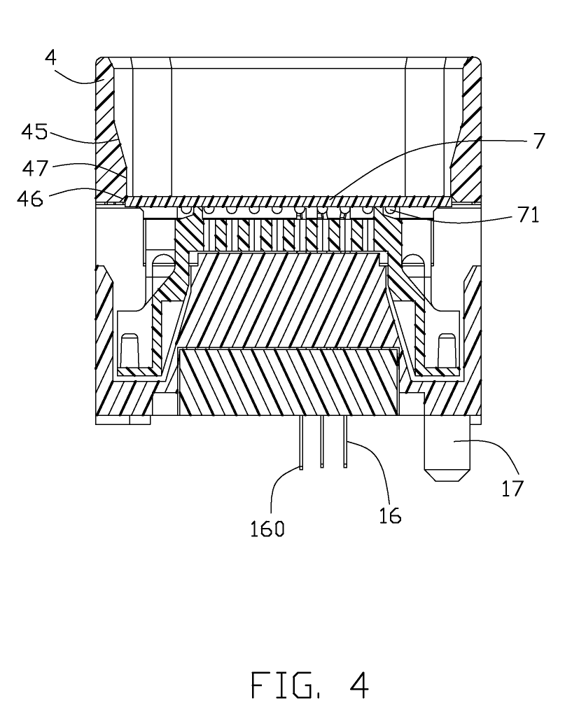

Referring to FIGS. 3 to 4, the actuator frame 4 has two upper guiding surfaces 45 on the two parallel side walls, and the distance between the top edge of the upper guiding surfaces 45 is wider than distance between the bottom edge of the upper guiding surfaces 45, once the CPU 7 set in the connector, the upper guiding surfaces 45 guide it to the right place. The actuator frame 4 defines two lower guiding surfaces 46 on the lower edge and two vertical surfaces 47 between the upper and lower guiding surfaces 45, 46. The distance between the lower guiding surfaces 46 is decreasing from lower to upper, and the lower guiding surfaces 46 supply more spaces to adjust the CPU 7 to right position once the CPU 7 is set in the actuator frame 4, thus to avoid the sharp edge of the actuator frame from scratching the CPU 7.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A burn-in socket connector comprising:
an insulative main body defining an upper surface, a lower surface, and a plurality of passageways extending through the upper surface and the lower surface, the insulative main body further defining a plurality of slots opening at the upper surface but closed at the lower surface;
a slider carrying a plurality of contacts received in the passageways, the contact having a contacting portion extending beyond the upper surface and a tail portion extending below the lower surface for connecting with a printed circuit board;
a plurality of spring elements received in the slots; and
an actuator frame defining a receiving room for accommodating a CPU along a mating direction, the actuator frame being attached to the insulative main body from an upper side thereof, the actuator frame forming a plurality of posts positioned in the slots of the insulative body and resiliently bearing against the spring elements, the actuator frame comprising a pair of opposing walls, each opposing wall having, along the mating direction, a first, upper guiding surface protruding into the receiving room and a second, lower guiding surface sloping outward to increase a distance between the second lower guiding surfaces of the two opposing walls.

2. The burn-in socket connector as claimed in claim 1, wherein the actuator frame forms a third guiding surface between the first, upper guiding surface and the second, lower guiding surface, and the third guiding surface extends along the mating direction.

3. The burn-in socket connector as claimed in claim 1, wherein the insulative main body comprises a pair of lateral walls corresponding to the opposing walls of the actuator frame, and each lateral wall defines at least one groove and each opposing wall forms a latch correspondingly extending through the at least one groove and engaging with the lower surface of the insulative housing.

4. The burn-in socket connector as claimed in claim 1, wherein the slider moveably attaches to the insulative main body along a lengthwise direction perpendicular to the mating direction.

5. The burn-in socket connector as claimed in claim 4, further comprising an elastic element sandwiched between the slider and the insulative main body.

6. The burn-in socket connector as claimed in claim 5, wherein the elastic element is oriented to one of the slider and the insulative, main body by a column.

7. The burn-in socket connector as claimed in claim 5, wherein the actuator frame urges movement of the slider during the actuator frame moving to the insulative, main body.

8. The burn-in socket connector as claimed in claim 7, wherein the actuator frame forms a slant surface and the slider defines a curved surface mating to the slant surface, and the actuator frame is capable of urging the slider along the lengthwise direction.

9. The burn-in socket connector as claimed in claim 4, further comprising a bottom plate attached to a lower side of the insulative main body.

10. A burn-in socket comprising:
an insulative base equipped with a plurality of contacts, each of said contacts defining a contacting sections on a top portion;
a slider mounted upon and horizontally moveable relative to the housing to urge the contacting sections to move horizontally; and
an actuator mounted upon the base and above the slider to move the slider horizontally; wherein
the actuator defines an large upper receiving cavity for easily downwardly loading an electronic package thereinto from an exterior and a small lower receiving cavity for snugly receiving said electronic package therein and thus reliably restraining said electronic package in position for mechanically and electrically connecting to the contacting sections of the contacts.

11. The burn-in socket as claimed in claim 10, wherein a transition zone is located between the large upper receiving cavity and the small lower receiving cavity in a vertical direction.

12. The burn-in socket as claimed in claim 11, wherein said transition zone includes a downwardly converging tunnel formed by a plurality of oblique faces.

13. The burn-in socket as claimed in claim 12, wherein a plurality of biasing devices located between the actuator and the base to constantly urge said actuator upwardly.
